(19) United States
(12) Patent Application Publication
(10) Pub. No.: US 2017/0326014 A1
(43) Pub. Date: Nov. 16, 2017

(54) OPERATING TABLES, RELATED DEVICES, AND RELATED METHODS

(71) Applicant: Maquet GmbH, Rastatt (DE)

(72) Inventor: Martin STAUDINGER, Ettlingen (DE)

(73) Assignee: Maquet GmbH, Rastatt (DE)

(21) Appl. No.: 15/663,393

(22) Filed: Jul. 28, 2017

Related U.S. Application Data
(63) Continuation-in-part of application No. PCT/EP2016/052047, filed on Feb. 1, 2016.

(30) Foreign Application Priority Data
Feb. 5, 2015 (DE) 102015101658.3

(51) Int. Cl. A61G 13/02; A61G 13/12; F15B 13/04

(52) U.S. Cl. CPC A61G 13/02; F15B 13/0401; A61G 13/12; A61G 2203/10

(57) ABSTRACT

A hydraulic circuit for an operating table includes a hydraulic unit, a first hydraulic cylinder with a first chamber defined at least partially by a first leading active surface; and a second hydraulic cylinder with a second chamber defined at least partially by a second leading active surface; wherein: in a control operating mode of the hydraulic circuit, the first chamber is in fluid communication with only the second chamber, and in a maintenance operating mode of the hydraulic circuit, the first chamber and the second chamber are in fluid communication with the hydraulic unit.

### CROSS-REFERENCE TO RELATED APPLICATIONS

The present application is a continuation-in-part filed wider 35 U.S.C. §111(a), and claims the benefit under 35 U.S.C. §§365(c) and 371 of PCT International Application No. PCT/EP2016/052047, filed on Feb. 1, 2016, which designates the United States of America, and claims benefit of German Patent Application No. 10 2015 101 658.3, filed on Feb. 5, 2015. The disclosure of each of these applications is incorporated by reference herein in its entirety.

### TECHNICAL FIELD

The present disclosure relates to an operating table having a hydraulic system for adjusting a supporting surface of the operating table.

### BACKGROUND

Certain known operating tables include a hydraulic unit and a hydraulic cylinder system with two double-acting hydraulic cylinders. The two double-acting hydraulic cylinders of the hydraulic cylinder system form a series cylinder circuit. In such known systems, a manual valve is used to perform maintenance on the hydraulic cylinder system.

Such known operating tables have the disadvantage that performing maintenance on the hydraulic cylinder system is cumbersome and time-consuming. Moreover, a service technician must be called to actuate the manual valve, which results in high costs. Furthermore, a service technician is not always available.

In view of the above disadvantages associated with known operating tables, the object of the present disclosure is to provide an operating table that will allow maintenance to be performed on the hydraulic cylinder system of the operating table easily and quickly.

### BRIEF SUMMARY

In one exemplary aspect of the disclosure, a hydraulic circuit for an operating table includes a hydraulic unit, a first hydraulic cylinder with a first chamber defined at least partially by a. first leading active surface, and a second hydraulic cylinder with a second chamber defined at least partially by a second leading active surface. In a control operating mode of the hydraulic circuit, the first chamber is in fluid communication with only the second chamber, and in a maintenance operating mode of the hydraulic circuit, the first chamber and the second chamber are in fluid communication with the hydraulic unit,

In another exemplary aspect of the disclosure, an operating table includes a hydraulic unit with a pressure line and a return line, a first hydraulic cylinder with a first chamber defined at least partly by a first leading active surface, a second hydraulic cylinder with a second chamber defined at least partly by a second leading active surface, the first chamber being connected in series with the second chamber, and a hydraulic control system with a control operating mode and a maintenance operating mode. In the control mode the pressure line is in communication with the first chamber and the return line is in fluid communication with the second chamber, and in the maintenance operating mode, one of the pressure line and the return line is in fluid communication with the first chamber and the second chamber.

In yet another exemplary embodiment of the disclosure, a method of controlling an operating table includes controlling the operating table in a control operating mode, initiating a maintenance operating mode of the operating table based on one of a detected misalignment between a first hydraulic cylinder and a second hydraulic cylinder, a user input, and an elapsed time of the operating table operating in an operating mode. synchronizing the first hydraulic cylinder and the second hydraulic cylinder while the operating table is in the maintenance mode, and initiating the control operating mode of the operating table subsequent to synchronizing the first hydraulic cylinder and the second hydraulic cylinder.

Additional features and advantages of the present disclosure will be apparent from the following description, in which the features of the present disclosure are explained in reference to exemplary embodiments, in conjunction with the accompanying figures or may be learned by practice of the present disclosure.

It is to be understood that both the foregoing general description and the following detailed description are exemplary and explanatory only and are not restrictive of the present disclosure and claims.

### BRIEF DESCRIPTION OF THE DRAWINGS

FIG. 1A shows a perspective view of an operating table having a column and a supporting surface connected to the column, and comprising a back plate and a base plate, in accordance with an exemplary embodiment of the disclosure;

FIG. 1B shows the operating table of FIG. 1A, which additionally has a leg plate adjoining the base plate;

FIG. 2A shows a perspective view of the supporting surface of the operating table of FIG. 1A, with the base plate removed and the side rail opened;

FIG. 2B shows a further perspective view of the supporting surface of the operating table of FIG. 1A with the base plate and the partially opened side rail;

FIG. 3 shows a plan view of the supporting surface of the operating table of FIG. 1A with the back plate hidden and the base plate hidden;

FIG. 4 shows a perspective view of a hydraulic cylinder system according to an embodiment of the disclosure, separated from the supporting surface of FIG. 2A and comprising a first valve unit, a second valve unit and a third valve unit embodied as a synchronizing valve unit;

FIG. 5 shows a schematic diagram of a part of the hydraulic cylinder system shown in FIG. 4 with a first hydraulic cylinder and a second hydraulic cylinder; and

FIG. 6 shows a circuit diagram of the hydraulic cylinder system shown in FIG. 4.

An operating table in accordance with the present disclosure allows maintenance to be performed on a hydraulic cylinder system of the operating table easily and quickly. In various exemplary embodiments, a synchronizing valve unit for synchronizing the piston movements of the first hydraulic cylinder and the second hydraulic cylinder of the hydraulic cylinder system and a control unit for controlling the synchronizing valve unit are provided. The control unit sets the maintenance operating mode on the basis of a setting parameter. The hydraulic cylinder system can thus be maintained easily and quickly with the aid of the controllable synchronizing valve unit. Moreover, the actuation of a manual valve for the purpose of maintaining the hydraulic cylinder system can be avoided.

At a first setting value of the setting parameter, the control operating mode is set, and at a second setting value of the setting parameter, the maintenance operating mode is set.

In some embodiments, the setting parameter changes from the first setting value to the second setting value with the aid of user input. Thus, a change in operating mode from the control operating mode to the maintenance operating mode can be carried out with the aid of user input.

In some embodiments, a maintenance interval may be preset and stored in the control unit. The maintenance interval corresponds to an operating time since the last change in operating mode from the maintenance operating mode to the control operating mode. Maintenance can thus be performed on the hydraulic cylinder system with the aid of a stored preset maintenance interval.

At the end of the maintenance interval, the setting parameter changes from the first setting value to the second setting value. Thus, at the end of a predetermined operating time in the control operating mode, the operating mode can be changed from the control operating mode to the maintenance operating mode.

The stored preset maintenance interval may be a set time period, of, as a non-limiting example, at least one hour. Intervals of less than, or greater than, one hour are within the scope of the disclosure.

In various exemplary embodiments, the setting parameter changes from the first setting value to the second setting value in response to certain triggers or meeting certain thresholds. For example, in accordance with the present teachings, the setting parameter may change from the first setting value to the second setting value when a predetermined operating time in the control operating mode has elapsed, when a misalignment of the piston of the first hydraulic cylinder relative to that of the second hydraulic cylinder is detected in the control operating mode, or when a user input is implemented for a change in operating mode from the control operating mode to the maintenance operating mode. This enables the change in operating mode from the control operating mode to the maintenance operating mode to be carried out when a predetermined condition is met. In some instances, the change in operating mode may be automatic, while in other cases, the change may require user input.

In accordance with the present disclosure, in some exemplary embodiments, the operating table includes a control valve unit for controlling the hydraulic cylinder system. The control valve unit controls the hydraulic cylinder system in such a way that, in the maintenance operating mode, a rear cylinder chamber of the first hydraulic cylinder, disposed opposite the front cylinder chamber, is pressurized while at the same time a hydraulic fluid flows out of a rear cylinder chamber of the second hydraulic cylinder, disposed opposite the front cylinder chamber, so that the pistons of the first hydraulic cylinder and the second hydraulic cylinder are moved in the first piston movement direction. Alternatively, a rear cylinder chamber of the second hydraulic cylinder, disposed opposite the front cylinder chamber, is pressurized while at the same time a hydraulic fluid flows out of a rear cylinder chamber of the first hydraulic cylinder, disposed opposite the front cylinder chamber, so that the pistons of the first hydraulic cylinder and the second hydraulic cylinder are moved in the second piston movement direction. In addition, the control unit may actuate the synchronizing valve unit in such a way that, when in the maintenance operating mode, if the volume of hydraulic fluid in the connecting line is too great for synchronous piston movements of the first hydraulic cylinder and the second hydraulic cylinder, when the pistons move in the first piston movement direction, the hydraulic fluid flows out of the front cylinder chamber of the first hydraulic cylinder via the connecting line and the return flow line, and when the pistons move in the second piston movement direction, the hydraulic fluid flows out of the front cylinder chamber of the second hydraulic cylinder via the connecting line and the return flow line. If the volume of hydraulic fluid in the connecting line is insufficient for synchronous piston movements of the first hydraulic cylinder and the second hydraulic cylinder, when the pistons move in the first piston movement direction, the front cylinder chamber of the second hydraulic cylinder is pressurized via the pressure line and the connecting line, and when the pistons move in the second piston movement direction, the front cylinder chamber of the first hydraulic cylinder is pressurized via the pressure line and the connecting line. The piston movements of the first hydraulic cylinder and the second hydraulic cylinder of the hydraulic cylinder system can thereby be synchronized in the maintenance operating mode.

In some exemplary embodiments, the pistons of the first hydraulic cylinder and the second hydraulic cylinder are moved in the respective piston movement direction until they reach their end stop position. In this way, the hydraulic cylinder system can ultimately be moved to a starting position for the control operating mode.

Once the pistons of the first hydraulic cylinder and of the second hydraulic cylinder reach their respective end stop positions, each is moved in a piston movement direction opposite the respective piston movement direction, and is then moved back in its original piston movement direction until each arrives back at its end stop position. The method for synchronizing the piston movements of the first hydraulic cylinder and the second hydraulic cylinder of the hydraulic cylinder system can thus be carried out repeatedly, so that the starting position of the hydraulic cylinder system for the control operating mode is reliably reached.

In accordance with one aspect of the present disclosure, in some exemplary embodiments, the operating table includes an output unit for issuing a request for user input for setting the maintenance operating mode. A person using the operating table can thus be notified by means of the output unit that the hydraulic cylinder system requires maintenance.

in accordance with the teachings of the present disclosure, in some exemplary embodiments, the control unit changes to the maintenance operating mode only when it is determined by means of sensors that no patient is present on the patient supporting surface of the operating table, or when, following a request for user input for setting of the maintenance operating mode, corresponding user input has actually occurred. This ensures that maintenance of the hydraulic cylinder system will be carried out only when there is no risk of injury to a patient lying on the patient supporting surface, or when the user has confirmed setting of the maintenance operating mode.

As a non-limiting example, the synchronizing valve unit may be an electromagnetically controllable valve unit. The disadvantages of a manual valve can thereby be avoided.

The operating table may include a sensor, assigned only to the first hydraulic cylinder or only to the second hydraulic cylinder, for detecting the piston position of the hydraulic cylinder that is assigned to the sensor. Thus, rather than two sensors for each of the two hydraulic cylinders, a single sensor can be used to detect the position of the hydraulic cylinder system.

In some embodiments, the operating table includes an operating element, coupled to the control unit, for selecting the setting parameter for the operating mode in question. This enables the user to select the operating mode in each case by means of the operating element.

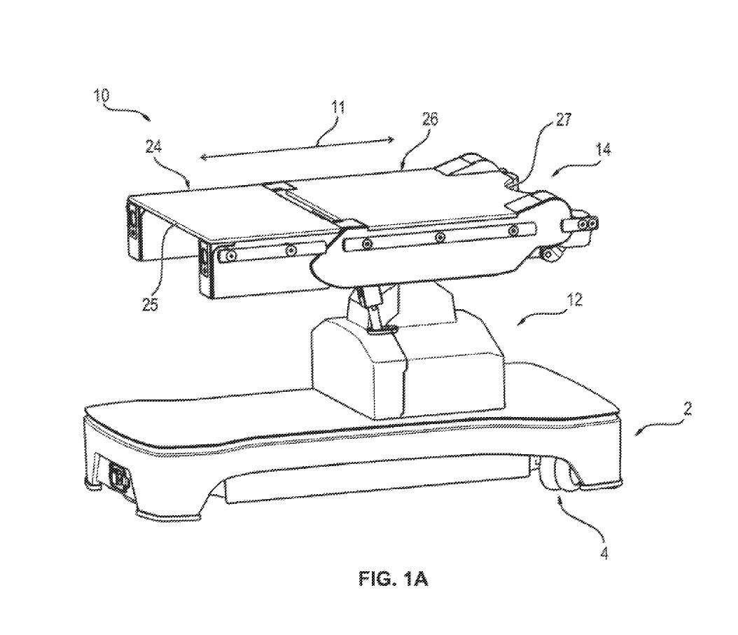

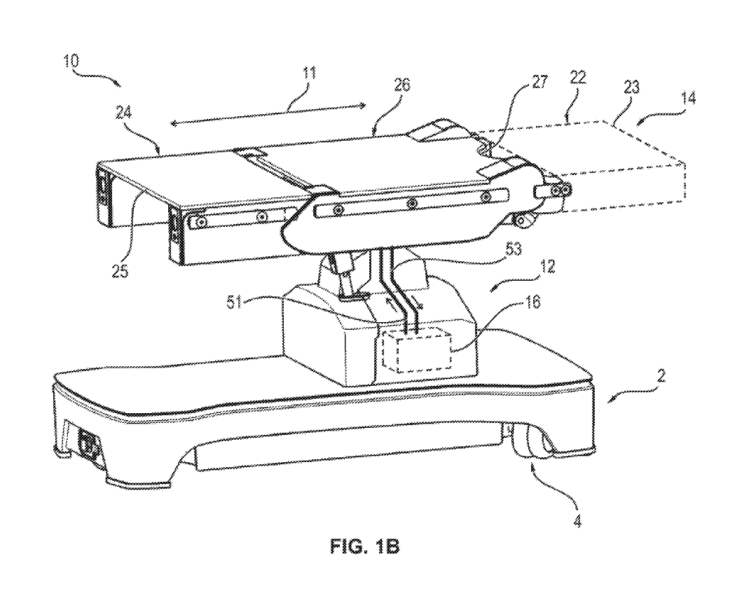

Referring now to the figures. FIG. 1A shows an operating table 10 with a column 12 and a supporting surface 14 connected to the column 12. As shown in FIG. 1A, the supporting surface 14 is connected to the upper end of column 12 such that the height, the tilt, and the inclination of the supporting surface 14 can be adjusted by means of drives that are arranged in column 12. As used herein, “inclination” refers to an orientation of the supporting surface 14 about a transverse axis that extends transversely to a longitudinal direction of the supporting surface 14, and “tilt” refers to an orientation of the supporting surface 14 about a longitudinal axis that extends parallel to the longitudinal direction of the supporting surface 14. The transverse axis and the longitudinal axis may be orthogonal to one another. An inclining movement to adjust the inclination is a movement about the transverse axis that extends transversely to the longitudinal direction of supporting surface 14, and a tilting movement to adjust the tilt is a movement about the longitudinal axis that extends parallel to the longitudinal direction of supporting surface 14. In addition, the lower end of column 12 is fixedly connected to a base 2 of operating table 10. In the exemplary embodiment shown in FIG. 1A, supporting surface 14 comprises two separate supporting surface segments 24, 26, which are mounted pivotably relative to one another. Supporting surface segment 24 comprises a back plate 2.5 and supporting surface segment 26 comprises a base plate 27. Supporting surface 14 can further comprise an additional supporting surface segment 22 having a leg plate 23, as illustrated in FIG. 1B. Also illustrated schematically in FIG. 1B is a hydraulic unit 16 arranged in column 12 and located behind a column side panel.

In the exemplary embodiment shown in FIG. 1A, supporting surface 14 is fixedly connected to column 12 and cannot be removed. Supporting surface 14 is displaceable in relation to column 12 in the longitudinal direction of supporting surface 14 along a. longitudinal displacement path, as indicated. by longitudinal displacement arrow 11. Operating table 10 can also comprise a hydraulic unit integrated into base 2 for displacing the supporting surface 14 in the longitudinal direction. As FIG. 1A further shows, base 2 comprises rollers 4, at least two of which are embodied as swivel rollers for moving operating table 10.

FIG. 19 shows the operating table of FIG. 1A, which additionally has a leg plate 23 adjoining base plate 27. FIG. 1B shows a hydraulic supply line 51, also called a pressure line, and a hydraulic return line 53, also called a tank line. In FIG. 19, the direction in which a hydraulic fluid flows through supply line 51 and return line 53 is indicated in each case by an arrow. In the exemplary embodiment shown in FIG. 1B, supporting surface 14 comprises the supporting surface segment 22 (which may be referred to as a first supporting surface segment 22) with leg plate 23, the supporting surface segment 24 (which may be referred to as a second supporting surface segment 24) with back plate 25, and the supporting surface segment 26 (which may be referred to as a third supporting surface segment 26) with base plate 27. The first supporting surface segment 22 and the second supporting surface segment 24 are each pivotable relative to the third supporting surface segment 26.

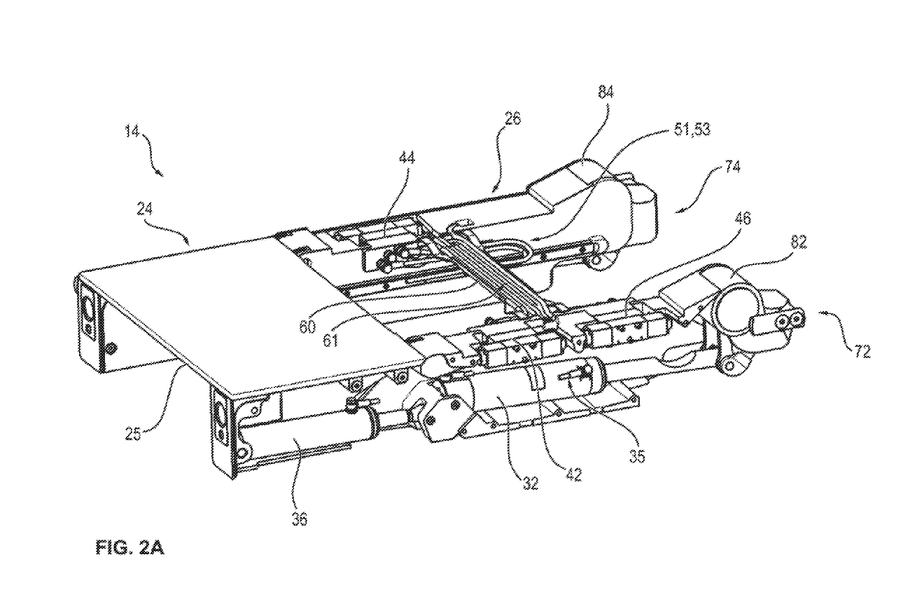

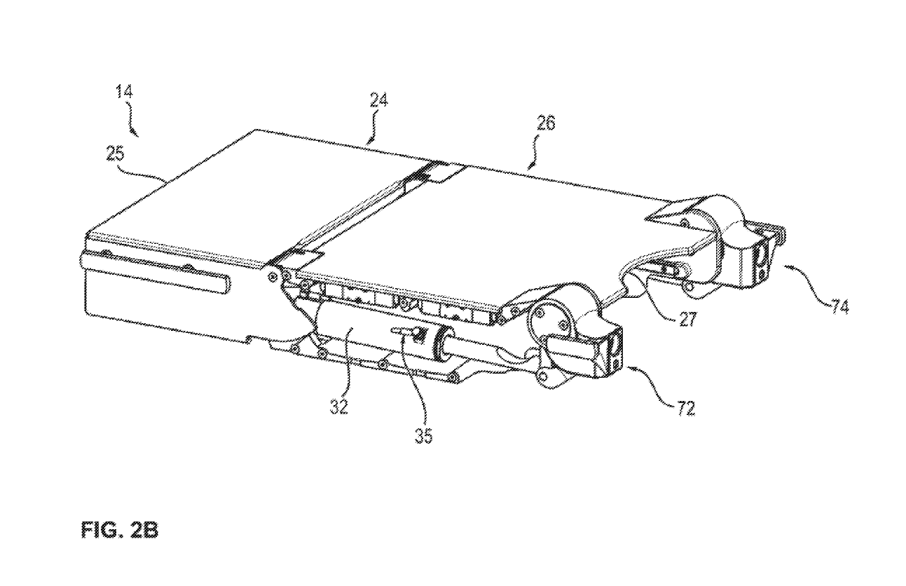

As is illustrated schematically by way of example in FIG. 1B, the hydraulic unit 16 arranged in column 12 does not extend into the area of base 2. FIG. 2A shows a perspective view of supporting surface 14 of the operating table 10 of FIG. 14, separated from column 12, and with base plate 27 removed. As shown in FIG. 2A, the supporting surface 14 has a first side rail 72 and a second side rail 74 opposite the first side rail 72. The first side rail 72 is shown opened in FIG. A.

In FIG. 2A, a hydraulic cylinder 32 of a first pair of hydraulic cylinders and a hydraulic cylinder 36 of a second pair of hydraulic cylinders are shown. The opposing hydraulic cylinders of the first pair and of the second pair are arranged in the second side rail 74 and are not visible in FIG. 2,4. The first pair of hydraulic cylinders is provided for adjusting a first supporting surface segment of supporting surface 14, for example, the first supporting surface segment 22 shown in FIG. 1B and having leg plate 23, and the second pair of hydraulic cylinders is provided for adjusting a second supporting surface segment of supporting surface 14, for example, the second supporting surface segment 24 shown in FIGS. 1A to 2A and having hack plate 25. FIG. 2A further illustrates that the hydraulic cylinders 32, 36 have different connections 35 for hydraulic hoses.

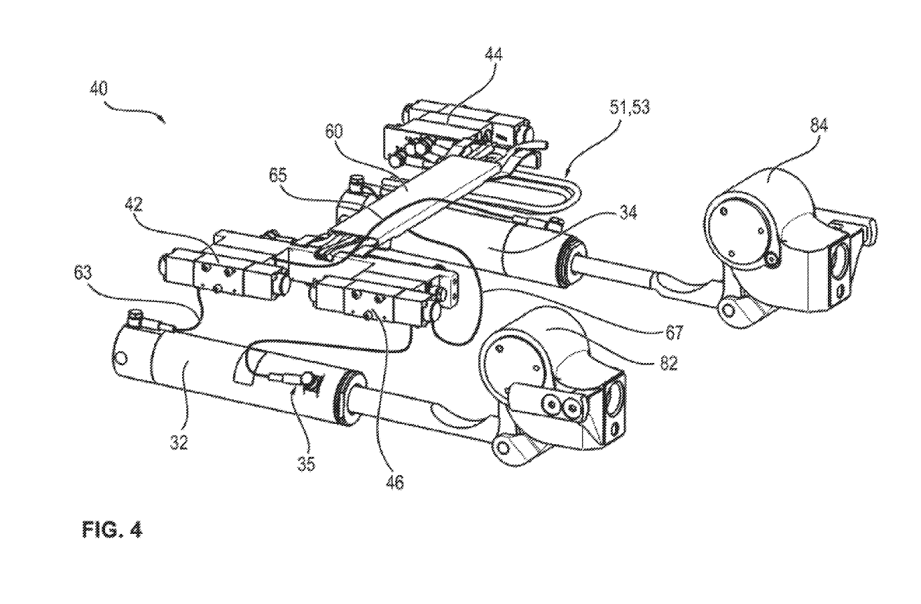

The supporting surface 14 shown in FIG. 2A comprises a first valve unit 42, a second valve unit 44, and a third valve unit 46. The first valve unit 42 is integrated into supporting surface 14 and serves to control the first pair of hydraulic cylinders, and the second valve unit 44, integrated into supporting surface 14, serves to control the second pair of hydraulic cylinders. The function of the third valve unit 46 integrated into supporting surface 14 will be explained in greater detail below in reference to FIGS. 4 through 6.

FIG. 2A shows supply line 51 and return line 53. Referring to FIGS. 1B and 2A, the first valve unit 42 and the second valve unit 44 are connected hydraulically to hydraulic unit 16 only via supply line 51 and return line 53.

FIG. 2A shows a cross connection (or crossmember) 60, which extends between the first side rail 72 and the second side rail 74. The cross connection 60 serves to accommodate hoses 61 that extend between the first side rail 72 and the second side rail 74, connecting the valve units (e.g., valve s 42, 44, 46) to the hydraulic cylinders (e.g., hydraulic cylinders 32, 36). The cross connection 60 is preferably fixedly connected to the first side rail 72 and the second side rail 74.

As shown in FIG. 2A, supporting surface 14 comprises leg brackets 82, 84 for attaching supporting surface segment 22, which has leg plate 23 as illustrated in FIG. 1B. The leg brackets 82, 84 are arranged in the two opposing side rails 72, 74.

FIG. 23 shows a perspective view of the supporting surface 14 of operating table 10 of FIG. 1A with the base plate 27 and with the side rail 72 partially opened. In FIG. 23, only hydraulic cylinder 32 is visible, while hydraulic cylinder 36 along with the first, second, and third valve units 42, 44, 46, supply line 51 and return line 53, and cross connection 60, all of which are arranged beneath base plate 27, are not visible.

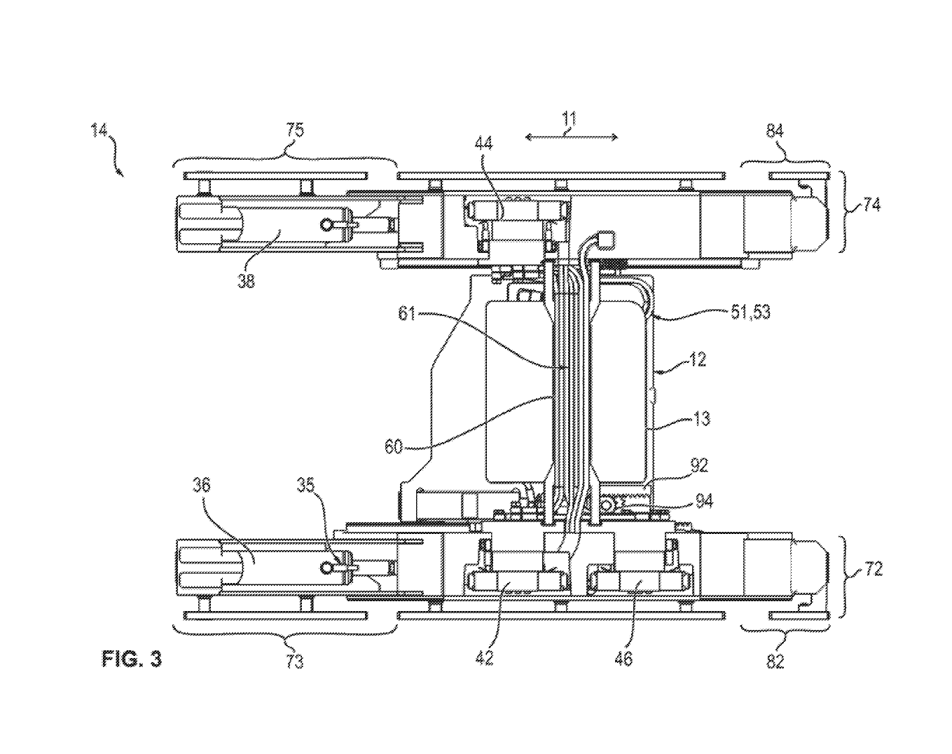

FIG. 3 shows a plan view of supporting surface 14 of operating table 10 of FIG. 1A with back plate 25 hidden and base plate 27 hidden. In the plan view of FIG. 3, the hydraulic cylinders 36, 38 of the second pair, which are arranged in sections 73, 75 of side rails 72, 74 beneath the hidden back plate 25, are visible. Also visible in the plan view of FIG. 3 are the first, second, and third valve units 42, 44, 46, supply line 51 and return line 53, and cross connection 60 with hoses 61.

In FIG. 3, the direction of longitudinal displacement of the supporting surface 14 along a longitudinal displacement path is indicated by longitudinal displacement arrow 11. When the supporting surface 14 is displaced longitudinally, all the components that are integrated into supporting surface 14, in particular cross connection 60, which is fixedly connected to side rails 72, 74, move along with supporting surface 14. Column 12 with the column head 13, shown in FIG. 3, is immovably arranged in this case. As shown in FIG. 3, the supply line 51 and the return line 53 are installed at least partially in an area of the column 12 that faces a longitudinal side of the supporting surface 14, in a compensating loop to compensate for movement of the supporting surface 14 during longitudinal displacement.

As is shown in FIG. 3, operating table 10 comprises an electric linear drive, for example, having a gear wheel 94 for generating the longitudinal displacement. Gear wheel 94 meshes with a gear rack 92, so that when gear wheel 94, which is driven by an electric motor (not shown), is rotated, supporting surface 14 is displaced relative to column 12. Alternatively or additionally, operating table 10 may also comprise a hydraulic linear drive for generating the longitudinal displacement.

FIG. 4 shows a perspective view of a hydraulic cylinder system 40 comprising the first valve unit 42, the second valve unit 44, and the third valve unit 46. In the embodiment of FIG. 4, each of the valve units 42, 44, and 46 comprise synchronizing valve units. The hydraulic cylinder system 40 shown in FIG. 4 comprises hydraulic cylinder 32 and hydraulic cylinder 34. As shown in FIG. 4, the hydraulic cylinder system 40 is formed by the first pair of hydraulic cylinders 32, 34. Alternatively or additionally, the second pair of hydraulic cylinders 36, 38 of FIG. 3 may also form a corresponding hydraulic cylinder system.

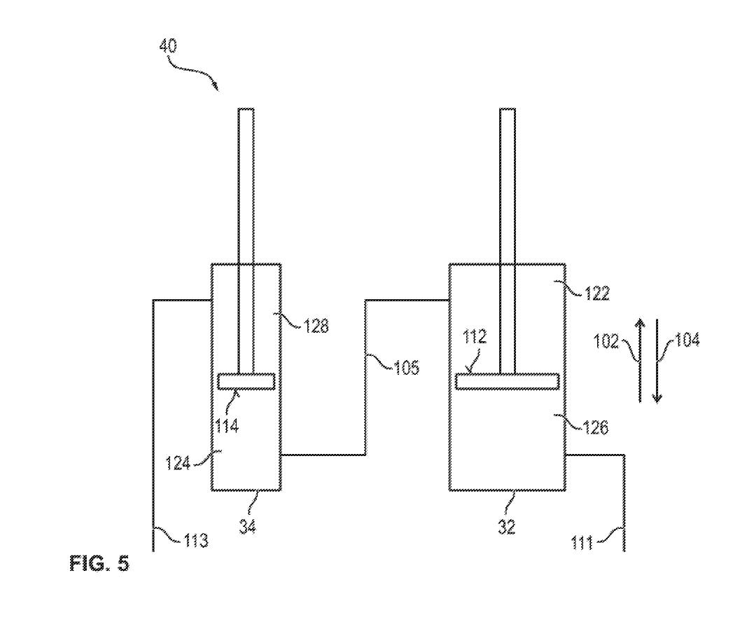

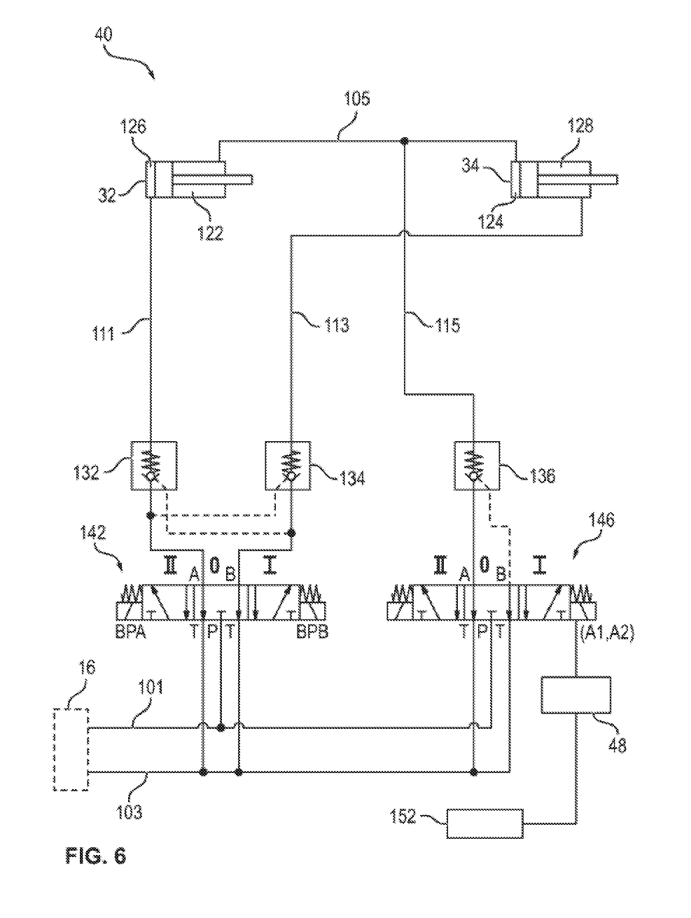

As is shown in FIG. 4, the first hydraulic cylinder 32 and the second hydraulic cylinder 34 are each connected to the first valve unit 42 via a hose 63, 65. In addition, the first hydraulic cylinder 32 and the second hydraulic cylinder 34 are connected in series via a connecting hose 67. Connecting hose 67 can be connected either to supply line 51 shown in FIG. 1B or to return line 53 shown in FIG. 1B via the third valve unit 46, which, in the exemplary embodiment of FIG. 4, comprises a synchronizing valve unit. Using the hydraulic cylinder system 40 shown in FIG. 4, a clocking or the synchronization of the clocking of the first hydraulic cylinder 32 and the second hydraulic cylinder 34 can be achieved. This will be explained in greater detail below with reference to FIGS. 5 and 6.

FIG. 5 shows a schematic diagram of the hydraulic cylinder system 40 shown in FIG. 4, comprising the first hydraulic cylinder 32 and the second hydraulic cylinder 34. As shown in FIG. 5, the first hydraulic cylinder 32 and the second hydraulic cylinder 34 are double-acting hydraulic cylinders having a first piston movement direction 102 and a second piston movement direction 104. The first piston movement direction 102 and the second piston movement direction 104 are opposite one another. In the hydraulic cylinder system 40 shown in FIG. 5, a leading active surface 112 of the first hydraulic cylinder 32 in the first piston movement direction 102 and a leading active surface 114 of the second hydraulic cylinder 34 in the second piston movement direction 104 are the same size (i.e., have the same area). In addition, a cylinder chamber 122 adjoining active surface 112 of the first hydraulic cylinder 32 and a cylinder chamber 124 adjoining active surface 114 of the second hydraulic cylinder 34 are connected to one another via a connecting line 105. Furthermore, a cylinder chamber 126 of the first hydraulic cylinder 32 and a cylinder chamber 124 of the second hydraulic cylinder 34 which are not connected to connecting line 105 are connected to hydraulic lines 111, 113, respectively. Connecting line 105, shown in FIG. 5, comprises the connecting hose 67 shown in FIG. 4, for example, whereas hydraulic lines 111, 113 of FIG. 5 comprise the hoses 63, 65 of FIG. 4, for example. Connecting line 105 shown in FIG. 5 may be referred to as a dead leg.

In the hydraulic cylinder system 40 shown in FIG. 5, the double-acting hydraulic cylinders 32, 34 are each single-rod cylinders, with the active surface 112 of the first hydraulic cylinder 32 being an annular piston surface and the active surface 114 of the second hydraulic cylinder 34 being a circular piston surface. Alternatively, the double-acting hydraulic cylinders 32, 34 may be double-rod cylinders, in which case active surface 112 of the first hydraulic cylinder 32 and active surface 114 of the second hydraulic cylinder 34 are annular piston surfaces of the same size (not shown).

Using the hydraulic cylinder system 40 shown in FIG. 5, the clocking of the two double-acting hydraulic cylinders 32, 34 can be achieved. In addition, with the hydraulic cylinder system 40 shown in FIG. 5, and using the third valve unit 46 shown in FIG. 4 and embodied as a synchronizing valve unit, the clocking of the two double-acting hydraulic cylinders 32, 34 can be synchronized. This will be explained below with reference to the circuit diagram shown in FIG. 6,

FIG. 6 shows a circuit diagram for the hydraulic cylinder system 40 shown in FIG. 4 and having the first hydraulic cylinder 32 and the second hydraulic cylinder 34. The circuit diagram also comprises a first directional control valve 142 and a second directional control valve 146. The directional control valves 142, 146 shown in FIG. 6 are, for example, 5/3 directional control valves. Furthermore, the first directional control valve 142 with check valves 132, 134 shown in FIG. 6 corresponds substantially to the first valve unit 42 of FIG. 4, and the second directional control valve 146 with the check valve 136 shown in FIG. 6 corresponds substantially to the third valve unit 46 of FIG. 4. To synchronize the clocking of the first hydraulic cylinder 32 and the second hydraulic cylinder 34, in a synchronized operating state connecting line 105 can be connected via the second directional control valve 146 either to a pressure line 101 that is connected to hydraulic unit 16 or to a return flow line 103 that is connected to hydraulic unit 16. For example, the pressure line 101 shown in FIG. 6 corresponds to supply line 51 shown in FIG. 1, and the return flow line 103 shown in FIG. 6 corresponds to return line 53 shown in FIG. 1B.

In the clocked operating state, the piston movements of the first hydraulic cylinder 32 and the second hydraulic cylinder 34 are synchronous. In this state, the second directional control valve 146 is closed, i.e., the connecting line 105 is not connected to either pressure line 101 or return flow line 103.

Hydraulic cylinders 32, 34 are shown with hydraulic lines 111, 113 and a line section 115 of connecting line 105. As is illustrated by way of example in FIG. 6, check valves 132, 134 are arranged in hydraulic lines 111, 113, respectively, while another check valve 136 is arranged in line section 115. Check valves 132, 134 form a double-releasable check valve system, which is arranged between the first directional control valve 142 and the hydraulic cylinders 32, 34. Check valves 132, 134 of the double-releasable check valve system can be hydraulically released in the direction of the respective hydraulic cylinders 32, 34, i.e. in a direction opposite the locking direction. In the embodiment of FIG. 6, check valve 136 is also a releasable check valve, and is arranged between the second directional control valve 146 and the hydraulic cylinder system 40. The releasable check valve 136 can be hydraulically released in the direction of hydraulic cylinder system 40, i.e., in a direction opposite the locking direction. Pressure line 101 is connected to the pressure port of the pump of hydraulic unit 16, and the return flow line 103 is connected to a tank of the hydraulic unit 16,

The functioning of the first directional control valve 142 and of the second directional control valve 146 will be explained below by way of example. When the first directional control valve 142 is in a home position (“0”), the first hydraulic line 111 is connected to return flow line 103 via the first directional control valve 142. Additionally, when the first directional control valve 142 is in the home position (“0”), the second hydraulic line 113 is connected to return flow line 103 via the first directional control valve 142. When the first directional control valve 142 is in the home position (“0”), no hydraulic fluid can flow out of the cylinder chambers 126, 128 of hydraulic cylinders 32, 34 since the double-releasable check valve system with check valves 132, 134 is closed.

When the first directional control valve 142 is in a second position (I), the first hydraulic line 111 is connected to return flow line 103 via the first directional control valve 142. Additionally, when the first directional control valve 142 is in the second position (I), the second hydraulic line 113 is connected to pressure line 101 via the first directional control valve 142. When the first directional control valve 142 is in the second position (I), cylinder chamber 128 of the second hydraulic cylinder 34 can be pressurized via pressure line 101 and the second hydraulic line 113, and the hydraulic fluid can flow out of cylinder chamber 126 of the first hydraulic cylinder 32 via first hydraulic line 111 and return flow line 103.

When the first directional control valve 142 is in a. third position (II), the first hydraulic line 111 is connected to pressure line 101 via the first directional control valve 142. Additionally, when the first directional control valve 142 is in the third position (II), the second hydraulic line 113 is connected to return line 103 via the first directional control valve 142. When the first directional control valve 142 is in the third position (II), cylinder chamber 126 of the first hydraulic cylinder 32 can be pressurized via pressure line 101 and the first hydraulic line 111, and the hydraulic fluid can flow out of cylinder chamber 128 of the second hydraulic cylinder 34 via second hydraulic line 113 and return flow line 103,

When the first directional control valve 142 is in the second position (I), the first check valve 132 leased, and when the first directional control valve 142 is in the third position (II), the second check valve 134 is released. Thus, when the first directional control valve 142 is in the second position (I) or the third position (II), the clocking of hydraulic cylinders 32, 34 with the two different piston movement directions 104 and 102 can be achieved. Moreover, when the first directional control valve 142 is in the home position (“0”), hydraulic fluid can be prevented from flowing out of the hydraulic cylinders 32, 34.

When the second directional control valve 146 is in a home position (“0”), line section 115 is connected to return flow line 103 via the second directional control valve 146. When the second directional control valve 146 is in a second position (1), line section 115 is connected to return flow line 103 via the second directional control valve 146. When the second directional control valve 146 is in a third position (II), line section 115 is connected to pressure line 101 via the second directional control valve 146. When the second directional control valve 146 is in the home position (“0”), no hydraulic fluid can flow out via line section 115 and return flow line 103 since check valve 136 is locked. When the second directional control valve 146 is in the second position (I), the hydraulic fluid can flow out of connecting line 105 via line section 115 and return flow line 103 since check valve 136 is released. When the second directional control valve 146 is in the third position (II), connecting line 105 can be pressurized via line section 115 and pressure line 101. Thus, when the second directional control valve 146 is in the second position (I), hydraulic fluid can flow out of connecting line 105, and when it is in the third position (II), connecting line 105 can be pressurized. This enables the clocking of the hydraulic cylinders 32, 34 to be synchronized.

One exemplary procedure for synchronizing the clocking is as follows. First, cylinder chamber 128 of the second hydraulic cylinder 34 is pressurized, while at the same time, the hydraulic fluid flows out of cylinder chamber 126 of the first hydraulic cylinder 32 into return flow line 103. This causes the piston of the second hydraulic cylinder 34 and the piston of the (downstream) first hydraulic cylinder 32 in FIG. 6 to move to the left or in the second piston movement direction 104.

If the volume of hydraulic fluid in connecting line 105 is too great for synchronous piston movements of the first hydraulic cylinder 32 and the second hydraulic cylinder 34, the piston of the first hydraulic cylinder 32 will reach its end stop first, before the piston of the second hydraulic cylinder 34 has reached its end stop. In that case, the third valve unit 46, i.e. the second directional control valve 146, can be controlled in order to allow the hydraulic fluid to flow out of cylinder chamber 124 of the second hydraulic cylinder 34 via connecting line 105 and return flow line 103. In addition, cylinder chamber 128 of the second hydraulic cylinder 34 can continue to be pressurized. In that way, the piston of the second hydraulic cylinder 34 will ultimately also reach its end stop.

If the volume of hydraulic fluid in connecting line 105 is too small for synchronous piston movements of the first hydraulic cylinder 32 and the second hydraulic cylinder 34, the piston of the second hydraulic cylinder 34 will reach its end stop first, before the piston of the first hydraulic cylinder 32 has reached its end stop. In that case, the third valve unit 46 (or the second directional control valve 146) can be controlled in order to allow cylinder chamber 122 of the first hydraulic cylinder 34 to be pressurized via pressure line 101 and connecting line 105. In addition, hydraulic fluid can continue to flow out of cylinder chamber 126 of the first hydraulic cylinder 32. In that way, the piston of the first hydraulic cylinder 32 will ultimately also reach its end stop.

Cylinder chamber 126 of the first hydraulic cylinder 32 or the piston of the first hydraulic cylinder 32 located at the end stop can then be pressurized, while at the same time, hydraulic fluid can flow out of cylinder chamber 128 of the second hydraulic cylinder 34, Moreover, the third valve unit 46 (or the second directional control valve 146) is closed during this time, so that no hydraulic fluid can flow out of connecting line 105. As a result, the piston of the first hydraulic cylinder 32 and the piston of the (downstream) second hydraulic cylinder 34 each move out of their end stops in FIG. 6 toward the right, or in the first piston movement direction 102. A clocking of the hydraulic cylinders 32, 34 in the first piston movement direction 102 can thereby be achieved.

By reversing the above procedure correspondingly, a clocking of the hydraulic cylinders 32, 34 in the second piston movement direction 104 can also be achieved. Thus, the clocking of the hydraulic cylinders 32, 34 (i.e. the two double-acting hydraulic cylinders always move identically) can be synchronized. Furthermore, the afore-mentioned procedure can also be carried out repeatedly.

In the afore-mentioned procedure, control valve unit 42 serves to control hydraulic cylinder system 40, and a control unit 48 (see FIG. 6) serves to actuate synchronizing valve unit 46. Further, the synchronized operating state corresponds to a maintenance operating mode, and the clocked operating state corresponds to a control operating mode.

As shown in FIG. 6, operating table 10 comprises a control unit 48 and an operating element 152 coupled to the control unit 48. Synchronizing valve unit 46 can be controlled electromagnetically with the aid of the control unit 48. The control unit 48 serves to control the synchronizing valve unit 46. The control unit 48 sets the maintenance operating mode on the basis of a mode setting parameter. Further, the operating element 152, which is coupled to the control unit 48, serves to set the setting parameter for the operating mode in question. This enables maintenance of the hydraulic cylinder system 40 to be carried out easily and quickly.

The respective operating mode is determined by the fact that, at a first setting value A1 of the mode setting parameter, the control operating mode is set, and at a second setting value A2 of the mode setting parameter, the maintenance operating mode is set.

As a specific, non-limiting example, the mode setting parameter changes from the first value A1 to the second value A2 when a certain condition is met. This condition is met, for example, when a predetermined operating time in the control operating mode has elapsed, when a misalignment of the piston of the first hydraulic cylinder 32 relative to that of the second hydraulic cylinder 34 in the control operating mode is detected, or when user input for a change in operating mode from the control operating mode to the maintenance operating mode is implemented. The predetermined operating time, also referred to as a maintenance interval, corresponds to an operating time since the last change in operating mode from the maintenance operating mode to the control operating mode.

In accordance with one aspect of the present disclosure, at the end of the maintenance interval, the change in operating mode from the control operating mode to the maintenance operating mode is carried out only when a further criterion is met. This criterion is considered met if it is determined, with the aid of sensors, that no patient is present on patient supporting surface 14 of operating table 10, or if, following a request for user input for the setting of the maintenance operating mode, corresponding user input takes place. This ensures that a patient lying on the patient supporting surface 14 will not be injured during the maintenance of hydraulic cylinder system 40, in which hydraulic cylinder system 40 reaches its end position,

In exemplary embodiments, sensors that are used for verifying the criterion that no patient is present on patient supporting surface 14 may comprise weight sensors, temperature sensors, and/or a camera. Additionally, the request for user input can be issued for the user by means of an output unit.

Operating tables according to various aspects of the present disclosure have the following exemplary advantages over known operating tables. Typically, four hydraulic cylinders are arranged in the supporting surface of a known operating table, two for adjusting the back plate and two for adjusting the leg plate. To supply these cylinders with hydraulic pressure, two hoses per cylinder are typically required, which must be routed from the valves in the column or base of the table up to the cylinders. In known devices, this results in a hose strand of eight hoses, which leads to installation space problems.

In known operating tables, a plurality of valve units and hydraulic hoses are arranged in the column. The hydraulic unit is arranged in the base of the operating table. A hose strand of eight hoses then runs from the valve units in the column into the column head, where the bundle is divided into four hoses for the left side rail and four hoses for the right-side rail. This is not desirable because a total of eight hoses must be guided from the column into the side rails of the supporting surface of the known operating table and must be carried along when a patient supporting surface of the known operating table is displaced longitudinally. The known operating table has a further disadvantage in that it is relatively difficult to install the hose bundle consisting of a total of eight hoses in a loop in order to compensate for the travel path of the patient supporting surface when the patient supporting surface is displaced longitudinally.

Exemplary embodiments of the present disclosure provide a hydraulically adjustable supporting surface for an operating table. It is an advantage of the present disclosure that the valves and valve units can be housed directly where they are required, specifically in the side rails 72, 74 of supporting surface 14. For example, one valve is located in each side rail 72, 74, one for actuating the back and one for the leg plate. In addition, a third valve 46 for a leg plate-specific function, for example, for synchronizing the clocking of the hydraulic cylinder system, can be provided in supporting surface 14. Since the cylinders that are actuated by respective valves are arranged both in the first side rail and in the second side rail, it is advantageous to provide hoses 61 between the side rails 72, 74 because the hoses 61 may be located immovably between the rails 72, 74 and move along with a longitudinal displacement actuation of the supporting surface 14. The hydraulic connection between hydraulic unit 16 and supporting surface 14 is achieved by a pressure line 101 and a tank line 103, which are routed into column 12 on one side of the supporting surface 14 in a loop serving as a compensating bend.

Embodiments of the present disclosure make it possible to use the installation space in column 12 for hydraulic unit 16. A hydraulic unit in base 2 can thereby be dispensed with, allowing the base to be shorter in height. In addition, more installation space is available in the base for other modules. Furthermore, the hydraulic unit can be connected to the supporting surface 14 by means of only two hoses (pressure line and tank line). Thus, not only are fewer hose lines required, but additional installation space is available due to the thinner hose bundle. Furthermore, the loop for bridging the longitudinal displacement path 11 can be implemented with only two hoses 101, 103. In contrast, the customary installation of hydraulic lines for bridging the longitudinal displacement path 11 with eight lines is possible only with a high installation space expenditure and installation effort. Furthermore, the teachings of the present disclosure allow the distance between the stop valves and the cylinders to be minimized. The greater the distance between a stop valve and a hydraulic cylinder, the softer the system and the more difficult it is to bleed. The proximity or the short distance between the stop valve and the hydraulic cylinder helps to optimize the system in terms of rigidity.

Furthermore, according to some embodiments of the disclosure, a modular table system can be constructed. For example, hydraulic unit 16 is located in column 12 and, in addition to a motor-pump unit, also includes the valves for actuating the column (e.g. for lifting, tilting and inclining), Additional hydraulic functions of the table can be implemented in the base, for example, for raising the base and extending the driving mechanism, in the column head, in particular for longitudinal displacement, and in the supporting surface for back actuation and leg actuation, in embodiments of the disclosure, the valve technology for the modules of base, column, column head, and supporting surface can be housed separately and in the respective modules. A modular system can thus be used for the development of additional operating tables and table variants, which allows individual functions to be omitted or included, without having to alter the hydraulic system. For example, for a table without a driving mechanism, the valves in the base can be omitted, or for a table without longitudinal displacement, for example, the valve in the column head can be omitted. in such cases, the remainder of the system and the hydraulic unit advantageously remain unchanged. In some embodiments, the base (e.g., base 2 shown in FIGS. 1A and 1B) can simply be eliminated and the column 12 can be attached directly to the floor.

In general, there are many applications in the art in which a series circuit of a so-called master/slave hydraulic cylinder system is implemented. One problem with such a circuit typically involves the line from the annular piston surface of the master cylinder to the circular piston surface of the slave cylinder, which is equal in area. The oil volume of this connection, also referred to as a dead leg, can change as a result of various factors, such as leakage, temperature fluctuations, released air, etc., and can thereby change the position of the two cylinders relative to one another.

According to the present disclosure, an improved arrangement is provided for the leg plates of the operating table, for example. This arrangement prevents individually attached plates from assuming an incorrect angle relative to one another if the volume of connecting line 105 should change, and if an integral accessory is used, this arrangement ensures that said accessory can still be mounted and removed. In particular, the operating table according to the present disclosure makes it possible to adjust the volume of connecting line 105.

With known operating tables, a series cylinder circuit is already installed. It is a disadvantage, however, that a number of locking screws are provided, which must be actuated by a service technician to restore the parallelism of the plates or the clocking of the cylinders. Other known systems function with compensating bores, which transition into the end stops. This method is disadvantageous, however, in that it cannot be used for reasons relating to tightness and installation space. Another known model of an operating table uses the principle of individual leg plate adjustment in a series connection of hydraulic cylinders. In that case, each cylinder receives a sensor, and it is possible to adjust each cylinder individually or both together. Then if the actuated elements should diverge, clocking can be restored by a brief individual actuation. However, this function requires additional valve technology, resulting in increased costs and installation space. A further disadvantageous option involves the use of mechanical couplings with a parallel hydraulic connection rather than a series circuit.

Exemplary embodiments of the disclosure make it possible to remove excess volumes from connecting line 105 or to till in missing volumes. According to the present disclosure, a synchronizing valve unit 46 is installed which allows connecting line 105 to be connected either to return flow line 103 or to pressure line 101 by means of electric actuation. In addition, a releasable check valve 136 is arranged between synchronizing valve unit 46 and connecting line 105 to ensure the tightness of connecting line 105.

If a change in volume in connecting line 105 occurs during operation of the operating table, so that individually attached plates are no longer parallel to one another or integral accessories can no longer be mounted or removed, the function of the operating table can be moved to the lower stop position. In that case, one of the two hydraulic cylinders 32, 34 is located in the stop position, while the other hydraulic cylinder is not yet in the stop position. The annular piston side of the slave cylinder then continues to be acted on by system pressure. By actuating synchronizing valve unit 46 alternatingly, connecting line 105 is then connected alternatingly to the tank and to the system pressure. This results in a “settling” until both hydraulic cylinders 32, 34 are in the hydraulic end stop position, and thus the hydraulic cylinder system 40 is aligned again. To enable this alignment procedure, the mechanism upstream and downstream of hydraulic cylinders 32, 34 must be adjusted during assembly such that, when both hydraulic cylinders 32, 34 are in the end stop position, the respective piston rods are parallel to one another.

The interconnection of the two hydraulic cylinders 32, 34 according to aspects of the disclosure enables an adjustment in the end stop position. Thus, one sensor is sufficient for detecting the position of hydraulic cylinder system 40. One sensor per cylinder is not required. The use of electromagnetic valve 46 according to the present disclosure allows the clocking of hydraulic cylinders 32, 34 to be aligned at any time, without the costly and time-consuming use of a service technician. Moreover, the elimination of a mechanical coupling of the two hydraulic cylinders 32, 34 is advantageous both in terms of costs and in terms of the reduction of the overall height of the operating table, since a mechanical coupling requires significantly more space than a hose connection between the left and right side rails 72, 74.

While the present teachings have been disclosed in terms of exemplary embodiments in order to facilitate a better understanding of the features of the present disclosure, it should be appreciated that the present teachings can be embodied in various ways without departing from the scope of the present disclosure. It will be further apparent to those skilled in the art that various modifications and variations can be made to the operating table columns of the present disclosure without departing from the scope of the disclosure. Other embodiments of the disclosure will be apparent to those skilled in the art from consideration of the specification and practice of the teachings disclosed herein. It is intended that the specification and embodiments described herein be considered as exemplary only.

1. A hydraulic circuit for an operating table, comprising:
a hydraulic unit;
a first hydraulic cylinder with a first chamber defined at least partially by a first leading active surface; and
a second hydraulic cylinder with a second chamber defined at least partially by a second leading active surface;
wherein:
in a control operating mode of the hydraulic circuit, the first chamber is in fluid communication only the second chamber, and
in a maintenance operating mode of the hydraulic circuit, the first chamber and the second chamber are in fluid communication with the hydraulic unit.

2. The hydraulic circuit of claim 1, wherein the first leading active surface of the first hydraulic cylinder has the same area as the second leading active surface of the second hydraulic cylinder.

3. The hydraulic circuit of claim 1, wherein at least a portion of the hydraulic circuit is contained within the operating table, and the operating table comprises a patient supporting surface comprising a first supporting surface segment, a second supporting surface segment, and a third supporting surface segment.

4. The hydraulic circuit of claim 3, wherein the first supporting surface and the second supporting surface are pivotably coupled to the third supporting surface segment.

5. The hydraulic circuit of claim 3, wherein the first hydraulic cylinder and the second hydraulic cylinder are configured to move the first supporting surface relative to the third supporting surface.

6. The hydraulic circuit of claim 1, wherein the first hydraulic cylinder and the second hydraulic cylinder are configured to move synchronously.

7. The hydraulic circuit of claim 1, further comprising a control unit configured to set the hydraulic circuit to the control operating mode or the maintenance operating mode.

8. The hydraulic circuit of claim 7. wherein the control unit is configured to set the hydraulic circuit to the maintenance operating mode based at least in part on a maintenance interval.

9. The hydraulic circuit of claim 7, wherein the control unit is further configured to detect patient presence or absence on a support surface of the operating table.

10. The hydra c circuit of claim 7, wherein the control unit is configured to set the hydraulic circuit to the control operating mode or the maintenance operating mode based on a user input.

11. The hydraulic circuit of claim 7, wherein the control unit is configured to set the hydraulic circuit to the maintenance operating mode based at least in part on a sensed misalignment between the first hydraulic cylinder and the second hydraulic cylinder.

12. An operating table, comprising:
a hydraulic unit with a pressure line and a return line;
a first hydraulic cylinder with a first chamber defined at least partly by a first leading active surface:
a second hydraulic cylinder with a second chamber defined at least partly by a second leading active surface, the first chamber being connected in series with the second chamber; and
a hydraulic control system with a control operating mode and a maintenance operating
mode,
wherein:
in the control mode, the pressure line is in communication with the first chamber and the return line is in fluid communication with the second chamber, and
in the maintenance operating mode, one of the pressure line and the return line is in fluid communication with the first chamber and the second chamber.

13. The operating table of claim 12, wherein the first leading active surface and the second leading active surface have a same area.

14. The operating table of claim 12, wherein a change in operating mode from the control operating mode to the maintenance operating mode occurs based on user input.

15. The operating table of claim 12, wherein a change in operating mode from the control operating mode to the maintenance operating mode occurs based on an elapsed time of the control system being in control operating mode following a last time the control system entered maintenance mode.

16. The operating table of claim 12, wherein the control system is configured to remain in the control operating mode based on a patient being present on the operating table.

17. A method of controlling an operating table, comprising:
controlling the operating table in a control operating mode;
initiating a maintenance operating mode of the operating table based on one of a detected misalignment between a first hydraulic cylinder and a second hydraulic cylinder, a user input, and an elapsed time of the operating table operating in an operating mode;
synchronizing the first hydraulic cylinder and the second hydraulic cylinder while the operating table is in the maintenance mode; and
initiating the control operating mode of the operating table subsequent to synchronizing the first hydraulic cylinder and the second hydraulic cylinder.

18. The method of claim 17, wherein operating the operating table in a control operating mode comprises moving a patient supporting surface with the first hydraulic cylinder and the second hydraulic cylinder.

19. The method of claim 17, wherein operating the operating table in a maintenance operating mode comprises fluidly coupling a chamber of the first hydraulic cylinder defined at least partly by a leading active surface of the first hydraulic cylinder and a chamber of the second hydraulic cylinder at least partly defined by a leading active surface of the second hydraulic cylinder with a hydraulic unit of the operating table.

20. The method of claim 17, wherein transitioning from the control operating mode to the maintenance operating mode comprises detecting, based on a signal from at least one sensor, a patient is not present on a patient supporting surface of the operating table.
